(19) United States
(12) Patent Application Publication
(10) Pub. No.: US 2013/0093618 A1
(43) Pub. Date: Apr. 18, 2013

(54) METHOD AND SYSTEM FOR IMPROVING ACCURACY OF POSITION CORRECTION DATA IN DIFFERENTIAL GLOBAL POSITIONING SYSTEM USING VEHICLE TO VEHICLE COMMUNICATION

(71) Applicants: Young Chul Oh, Hwaseong (KR); Yoon Ho Jang, Hwaseong (KR); Seong Su Im, Hwaseong (KR); Su Lyun Sung, Hwaseong (KR)

(72) Inventors: Young Chul Oh, Hwaseong (KR); Yoon Ho Jang, Hwaseong (KR); Seong Su Im, Hwaseong (KR); Su Lyun Sung, Hwaseong (KR)

(73) Assignee: HYUNDAI MOTOR COMPANY, Seoul (KR)

(21) Appl. No.: 13/353,660

(22) Filed: Jan. 19, 2012

(30) Foreign Application Priority Data
Oct. 17, 2011 (KR) 10-2011-0106079

(51) Int. Cl. G01S 19/07

(52) U.S. Cl. 342/357.44

(57) ABSTRACT

A method and system for improving accuracy of a position correction data in a differential global positioning system (DGPS) using vehicle to vehicle (V2V) communication, capable of correcting a DGPS data received from a road side unit (RSU) into information calculated by a sensor, and providing neighbouring vehicles with the corrected value as the DGPS data using the V2V communication, are provided.

### CROSS-REFERENCES TO RELATED APPLICATIONS

The priority of Korean patent application No. 10-2011-0106079 filed on Oct. 17, 2011, the disclosure of which is hereby incorporated in its entirety by reference, is claimed.

### BACKGROUND OF THE INVENTION

1. Field of the Invention

The present invention relates to technology for correcting a position of a vehicle, and more particularly, to a method and system for improving accuracy of a position correction data in a differential global positioning system (DGPS) using vehicle to vehicle (V2V) communication, configured to correct a DGPS data received from a road side unit (RSU) into information calculated by a sensor, and provide neighbouring vehicles with the corrected value as the DGPS data using the V2V communication.

2. Description of the Related Art

The Global Positioning System (GPS) is a space-based satellite navigation system that provides location and time information to remote devices located anywhere on or near the Earth. In order for most GPS devices to work properly, however, there typically must be an unobstructed line of sight to four or more GPS satellites. These systems are freely accessible by anyone with a GPS receiver.

Most GPSs have a typical kilometric error in positioning which ranges from about 5 to 15 meter and up to 30 m in some instances. Thus, the degree of accuracy for these systems is not as proficient as most automotive manufactures would like in order to provide a high degree of accuracy as to the vehicle's current location.

To supplement the known errors from the data received by the GPS satellite, a differential global positioning system real time kinematics (DGPS-RTKs) (hereinafter, referred to as ‘DGPSs’) has been widely used. DGPSs use a network of fixed, ground-based reference stations to broadcast the difference between the positions indicated by the satellite systems and the known fixed positions. These stations broadcast the difference between the measured satellite “pseudoranges” and actual (internally computed) “pseudoranges”. As a result receiver stations may use this information to correct their pseudoranges by the amount indicated.

However, DGPS services are limited to the coverage area of the base station, thus if a vehicle is not within range of the DGPS base station these stations are not able to provide the receiver with any error correction data.

### SUMMARY OF THE INVENTION

Various aspects of the present invention have been made in view of the above problems, and provide a method and system for improving accuracy of a position correction data in a differential global positioning system (DGPS) using vehicle to vehicle (V2V) communication, capable of correcting a DGPS data received from a road side unit (RSU) into information calculated by a sensor, and providing neighbouring vehicles with the corrected value as the DGPS data using the V2V communication.

According to an aspect of the present invention, a system for improving accuracy of a position correction data in a DGPS through V2V communication is provided. The system may include a GPS reception unit configured to receive a GPS data from a satellite, a V2V communication unit configured to transmit and receive a DGPS correction data, while communicating with a road side unit (RSU) or vehicles within a communication coverage, a sensor configured to detect a distance between his/her vehicle and another neighbouring vehicle within the communication coverage, a multi-hop data processing unit configured to retransmit the DGPS correction data received from the RSU or vehicles within the communication coverage as multi-hop information, through the V2V communication unit, according to a control data, and a control unit configured to compare and calculate information output from the GPS reception unit, the V2V communication unit, and the sensor to calculate a correction position of the vehicle and correction accuracy, compare the calculated correction accuracy to a predetermined reference value, and control the multi-hop data processing unit based on a compared result to retransmit the DGPS correction data.

Furthermore, when the calculated correction accuracy is less than the predetermined reference value, the control unit controls the multi-hop data processing unit to retransmit the DGPS correction data through the V2V communication unit.

The system may further include a DGPS error adjustment unit configured to improve an error for the DGPS correction data received from the RSU or the vehicles within the communication coverage based on information for the correction position of the vehicle calculated by the control unit and to output the improved DGPS correction data. The control unit allows the DGPS correction data improved by the DGPS error adjustment unit to be output through the V2V communication unit when the calculated correction accuracy is less than the predetermined reference value.

In the illustrative embodiment of the present invention, the sensor may be selected from any one of a group consisting of a laser sensor, radar, and an image sensor. The control unit may check whether or not a multi-hop count of the received DGPS correction data is greater than a predetermined value when the calculated correction accuracy is less than the predetermined reference value, and allow the DGPS correction data to be retransmitted when the multi-hop count is greater than the predetermined value.

The control unit may check whether or not a multi-hop count of the received DGPS correction data is less than a predetermined value when the calculated correction accuracy is less than the predetermined reference value, and control to allow the DGPS correction data to be re-received through the V2V communication unit when the multi-hop count is less than the predetermined value.

According to another aspect of the present invention, a method for improving accuracy of a position correction data using V2V communication is provided. The method may include receiving GPS information, receiving a DGPS correction data transmitted from a road side unit (RSU), performing correction for the GPS information based on the received DGPS correction data, receiving information for a distance to neighbouring another vehicle within a communication coverage and a relative position from a sensor embodied in a vehicle, calculating a correction position of the vehicle and accuracy of the DGPS correction data based on the information obtained from the performing correction for the GPS information and the receiving the information of the distance and the relative position, comparing the accuracy calculated from the calculating the correction position and the accuracy of the correction data to a predetermined reference value; and retransmitting the DGPS correction data depending on a result compared from the comparing the accuracy.

In some embodiments of the present invention, calculating the accuracy of the position data may include checking accuracy of the DGPS correction data received from the RSU based on the information for the distance to the neighbouring other vehicle and the relative position measured by the sensor. Additionally, retransmitting the DGPS correction data may include retransmitting the DGPS correction data only when it is determined that the calculated accuracy of the DGPS correction data is greater than the predetermined reference value.

The method may further include performing an error adjustment for the DGPS correction data based on the information received from the sensor. The re-transmitting the DGPS correction data may include performing transmission for the DGPS correction data by substituting the DGPS correction data adjusted in the performing the error adjustment for the DGPS correction data transmitted in the retransmitting the DGPS correction data when the accuracy of the position calculated in the comparing the accuracy of the correction data is greater than the predetermined reference value.

The systems and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The objects, features and advantages of the present invention will be more apparent from the following detailed description in conjunction with the accompanying drawings, in which:

FIG. 1 is a block diagram showing a configuration of a system for improving accuracy of a position correction data using vehicle to vehicle (V2V) communication according to an exemplary embodiment of the present invention.

FIG. 2A is a view explaining a process of generating and transmitting a DGPS data in a roadside unit (RSU).

FIG. 2B is a flow chart showing the operation of vehicle system configured with the configuration of FIG. 1.

FIG. 3 is a view explaining a concept of technology for improving accuracy of a position correction data accuracy using V2V communication according to an exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Hereinafter, exemplary embodiments of the present invention will be described with the reference to the attached drawings.

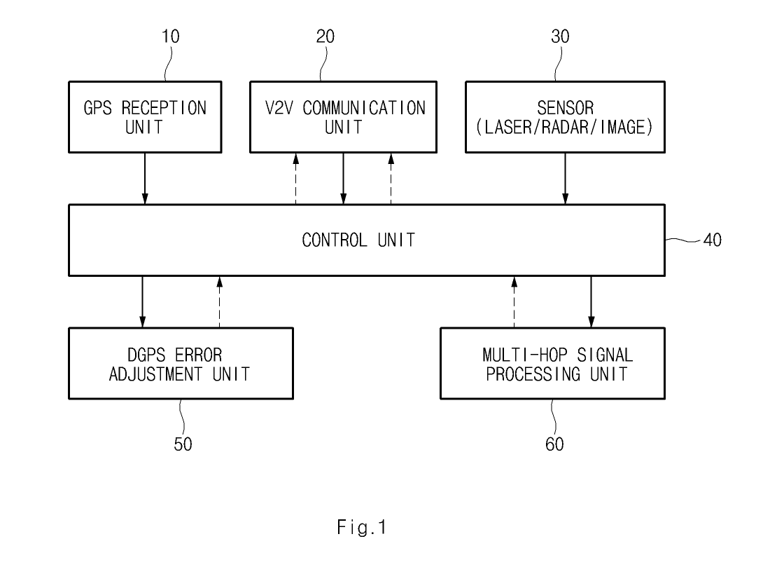

FIG. 1 is a block diagram showing a configuration of a system (e.g., installed in a vehicle) for improving accuracy of a position correction data in a differential global positioning system (DGPS) using vehicle to vehicle (V2V) communication according to an exemplary embodiment of the present invention. The reference numeral 10 denotes a GPS reception unit which receives a GPS data from a satellite. The reference numeral 20 denotes a V2V communication unit which transmits/receives the DGPS correction data, while communicating with a roadside unit (RSU) or vehicles within a communication coverage area. The reference numeral 30 denotes a sensor in which a position or distance measurement device such as a laser sensor, a radar or an image sensor is embodied and which detects position information such as a distance between his/her vehicle and neighbouring vehicles within the communication coverage.

In addition, the reference numeral 40 denotes a control unit which is configured to compare and calculate information output from the GPS reception unit 10, information output from the V2V communication unit 20, and information output from the sensor 30 to calculate a correction position of a vehicle and correction accuracy. The control unit then controls, according to the correction accuracy, the DGPS error adjustment unit 50 and a multi-hop data processing unit 60, which will be described below, to output output information through the V2V communication unit 20.

In FIG. 1, the reference numeral 50 denotes the DGPS error adjustment unit which corrects an error of the DGPS correction data received from the RSU unit or another vehicle based on information for the correction position of the vehicle calculated by the control unit 40 and outputs the error-corrected DGPS correction data. The reference numeral 60 denotes the multi-hop data processing unit which retransmits the DGPS correction data received from the RSU or the other vehicle as multi-hop information through the V2V communication unit 20 according to control of the control unit 40.

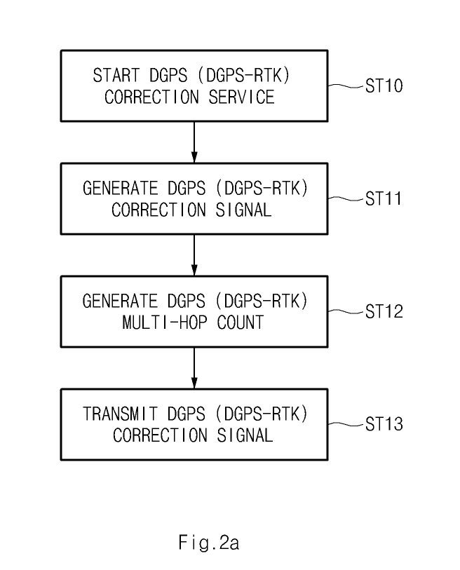

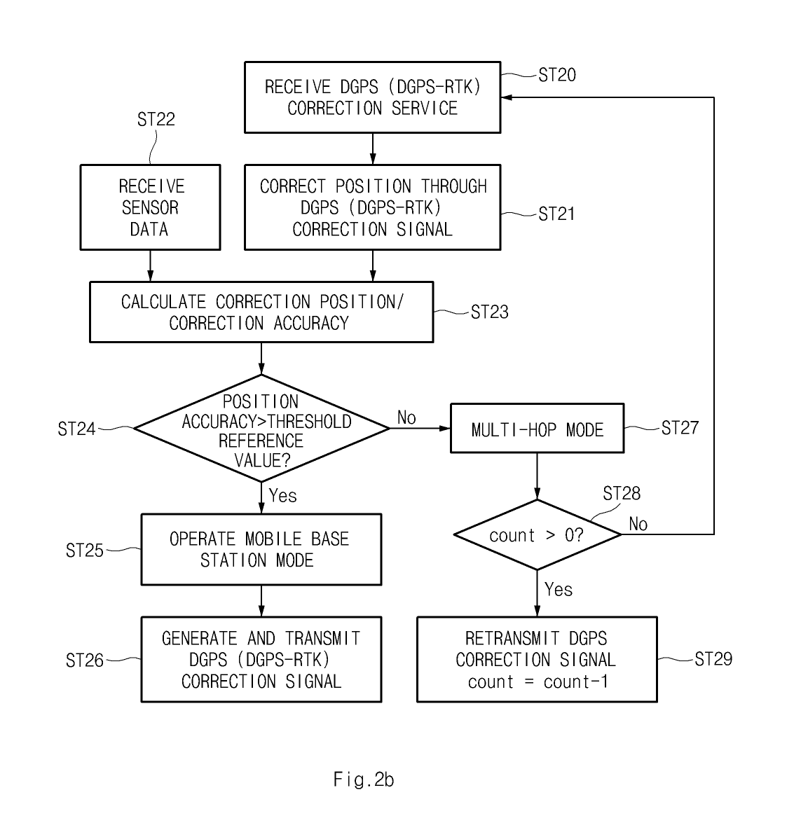

Below, an operation of the system having the above-described configuration will be described with reference to flowchart of FIGS. 2A and 2B. FIG. 2A is a sequence diagram illustrating a process of generating and transmitting a DGPS data from the RSU unit and FIG. 2B is a sequence diagram explaining an operation of a vehicle system having the configuration of FIG. 1.

As shown in FIG. 2A, when the RSU unit performs DGPS correction service (ST10), the RSU unit generates DGPS correction data based on the received GPS data and its own position information (ST11), generates a multi-hop count for preparing transmission by the multi-hop (ST12), and transmits the generated DGPS correction data and the multi-hop count through an antenna (ST13).

Meanwhile, as shown in FIG. 2B, when the V2V communication unit 20 receives the DGPS correction data transmitted from the RSU unit according to the above-described process (ST20), the control unit 40 of FIG. 1 executes correction for the GPS data received through the GPS reception unit 10 based on the received DGPS correction data (ST21), receives information for a distance to neighbouring another vehicle within the communication coverage and a relative position from the sensor 30 (ST22), and then calculates a correction position of the vehicle and accuracy of the correction data (position accuracy) based on the information received (ST23). That is, at step ST23, the control unit 40 checks the degree of the accuracy of the DGPS received from the RUS based on the information for the distance to the neighbouring vehicle within the communication coverage and the relative position measured by the sensor 30.

Subsequently, the control unit 40 checks whether the position accuracy calculated as the process result in step ST23 is greater than the predetermined threshold value (ST24), determines that the DGPS correction data is within a reliable level (predetermined by the manufacture), converts an operation mode into a mobile base station mode (ST25) according to a determination result, and controls the V2V communication unit 20 to transmit the DGPS correction data (ST26).

In addition, to improve the accuracy of the DGPS correction data, the control unit 40 controls the DGPS error adjustment unit 50 to execute the error adjustment for the DGPS correction data based on an output value of the sensor 30, and allows the error-adjusted DGPS correction data to be transmitted through the V2X communication unit 20 so as to be used as the DGPS correction data the DGPS correction data having higher accuracy. However, at step ST24, when it is determined that the position accuracy is less than the predetermined threshold value, the control unit 40 converts the operation mode into a multi-hop mode (ST27), checks whether a multi-hop count received from the RSU is greater than ‘0’ (ST28). When the multi-hop count is greater than ‘0’, the control unit 40 reduces the multi-hop by ‘1’, retransmits the DGPS correction data through the V2X communication unit 20 (ST29). When the multi-hop count is ‘0’, the control unit 40 returns to step ST20 and re-receives the DGPS correction data transmitted from the RSU.

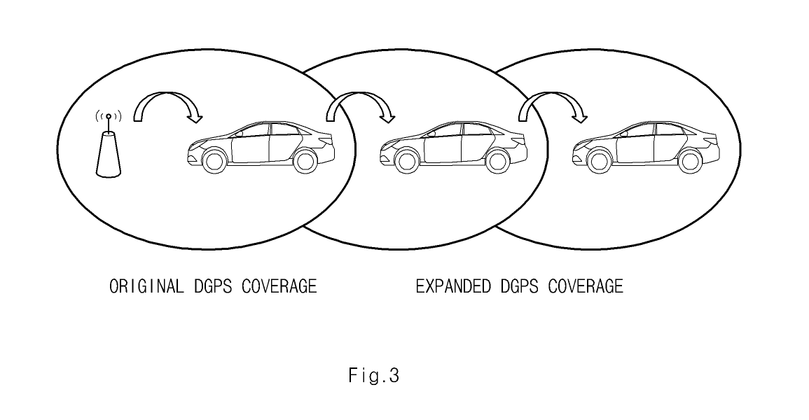

That is, according to the above exemplary embodiment, based on the information detected from the sensor in the vehicle itself and the correction data received from the RSU or another vehicle, it is possible to calculate more accurately the position of the vehicle and to improve the accuracy for the absolute and relative positions when operating in the DGPS mobile base station mode. Furthermore, it is possible to transmit and receive the position correction data calculated by the above-described process through V2V communication to obtain an effect of expanding a DGPS service coverage as shown in FIG. 3.

In the above illustrative embodiment, the control unit may be embodied as a controller or processor configured to execute the above processes. Furthermore, the control logic within the controller or processor of the present invention may be embodied as non-transitory computer readable media on a computer readable medium containing executable program instructions executed by the processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalent.

What is claimed is:

1. A system for improving accuracy of a position correction data in a differential global positioning system (DGPS) through vehicle to vehicle (V2V) communication, comprising:
a global positioning system (GPS) reception unit configured to receive a GPS data from a satellite;
a V2V communication unit configured to transmit and receive a DGPS correction data, while communicating with a road side unit (RSU) or other vehicles within a communication coverage;
a sensor configured to detect a distance between the vehicle and another neighboring vehicle within the communication coverage;
a multi-hop data processing unit configured to retransmit the DGPS correction data received from the RSU or the other vehicles within the communication coverage as multi-hop information, through the V2V communication unit, according to a control data; and
a control unit configured to compare and calculate information output from the GPS reception unit, the V2V communication unit, and the sensor installed in the vehicle to calculate a correction position of the vehicle and correction accuracy, compare the calculated correction accuracy to a predetermined reference value, and control the multi-hop data processing unit based on a compared result to retransmit the DGPS correction data.

2. The system according to claim 1, wherein when the calculated correction accuracy is less than the predetermined reference value, the control unit controls the multi-hop data processing unit to retransmit the DGPS correction data through the V2V communication unit.

3. The system according to claim 1, further comprising a DGPS error adjustment unit configured to improve an error for the DGPS correction data received from the RSU or the vehicles within the communication coverage based on information for the correction position of the vehicle calculated by the control unit and to output the improved DGPS correction data,
wherein the control unit controls the DGPS correction data improved by the DGPS error adjustment unit to be output through the V2V communication unit when the calculated correction accuracy is less than the predetermined reference value.

4. The system according to claim 1, wherein the sensor includes any one selected from the group consisting of a laser sensor, radar, and an image sensor.

5. The system according to claim 1, wherein the control unit checks whether or not a multi-hop count of the received DGPS correction data is greater than a predetermined value when the calculated correction accuracy is less than the predetermined reference value, and controls the DGPS correction data to be retransmitted when the multi-hop count is greater than the predetermined value.

6. The system according to claim 1, wherein the control unit checks whether or not a multi-hop count of the received DGPS correction data is less than a predetermined value when the calculated correction accuracy is less than the predetermined reference value, and controls the DGPS correction data to be re-received through the V2V communication unit when the multi-hop count is less than the predetermined value.

7. A method for improving accuracy of a position correction data using a vehicle to vehicle (V2V) communication, comprising:
receiving, by a reception unit in a vehicle, global positioning system (GPS) information;
receiving, by the reception unit in a vehicle, a differential global positioning system (DGPS) correction data transmitted from a road side unit (RSU);
performing, by a control unit, correction for the GPS information based on the received DGPS correction data;
receiving information for a distance to another neighboring vehicle within a communication coverage area and a relative position from a sensor embodied within the vehicle;
calculating, by the control unit, a correction position of the vehicle and accuracy of the DGPS correction data based on the information obtained from the performing correction for the GPS information and the receiving the information of the distance and the relative position;
comparing, by the control unit, the accuracy calculated from the calculating the correction position and the accuracy of the correction data to a predetermined reference value; and
retransmitting, by the control unit, the DGPS correction data depending on a result compared from the comparing the accuracy.

8. The method according to claim 7, wherein the calculating the accuracy of the position data includes checking accuracy of the DGPS correction data received from the RSU based on the information for the distance to the neighbouring other vehicle and the relative position measured by the sensor.

9. The method according to claim 7, wherein the retransmitting the DGPS correction data includes retransmitting the DGPS correction data only when it is determined that the calculated accuracy of the DGPS correction data is greater than the predetermined reference value.

10. The method according to claim 7, further comprising performing an error adjustment for the DGPS correction data based on the information received from the sensor,
wherein the re-transmitting the DGPS correction data includes performing transmission for the DGPS correction data by substituting DGPS correction data adjusted in the performing the error adjustment for the DGPS correction data transmitted in the retransmitting the DGPS correction data when the accuracy of the position calculated in the comparing the accuracy of the correction data is greater than the predetermined reference value.

11. A non-transitory computer readable medium containing program instructions executed by a processor or controller within a vehicle, the computer readable medium comprising:
program instructions that perform correction for received global positioning system (GPS) information based on received differential global positioning system (DGPS) correction data;
program instructions that calculate correction position of the vehicle and accuracy of the DGPS correction data based on the information obtained from the performing correction for the GPS information and information received related to a distance to another neighboring vehicle within a communication coverage and a relative position from a sensor embodied within the vehicle;
program instructions that compare the accuracy calculated from the calculating the correction position and the accuracy of the correction data to a predetermined reference value; and
program instructions that retransmit the DGPS correction data depending on a result compared from the comparing the accuracy.

12. The non-transitory computer readable medium according to claim 11, wherein the program instructions that calculate the accuracy of the position data includes program instructions that check the accuracy of the DGPS correction data received from the RSU based on the information for the distance to the neighbouring other vehicle and the relative position measured by the sensor.

13. The non-transitory computer readable medium according to claim 11, wherein the program instructions that retransmit the DGPS correction data include program instructions that retransmit the DGPS correction data only when it is determined that the calculated accuracy of the DGPS correction data is greater than the predetermined reference value.

14. The non-transitory computer readable medium according to claim 11, further comprising program instructions that perform an error adjustment for the DGPS correction data based on the information received from the sensor,
wherein the program instructions that retransmit the DGPS correction data includes program instructions that perform transmission for the DGPS correction data by substituting DGPS correction data adjusted in the performing the error adjustment for the DGPS correction data transmitted in the retransmitting the DGPS correction data when the accuracy of the position calculated during comparing the accuracy of the correction data is greater than the predetermined reference value.
